(19) United States
(12) Patent Application Publication
(10) Pub. No.: US 2013/0007656 A1
(43) Pub. Date: Jan. 3, 2013

(54) CONTENT AND WINDOW OVERLAY AND CONFIGURATION

(75) Inventors: Yongcheng Li, Cary, NC (US); Feng-Wei Chen, Cary, NC (US); Joseph D. Johnson, Raleigh, NC (US); John R. Hind, Raleigh, NC (US)

(73) Assignee: International Business Machines Corporation, Armonk, NY (US)

(21) Appl. No.: 13/174,575

(22) Filed: Jun. 30, 2011

(51) Int. Cl. G06F 3/048

(52) U.S. Cl. 715/790

(57) ABSTRACT

Some embodiments of the inventive subject matter are directed to selecting an area of a first window, which contains first content, in response to user input, generating a second window that contains second content that is substantially similar to a portion of the first content contained within the area of the first window, and superimposing the second window over a target window. The target window can be the first window or a third window. Some embodiments are further directed to affixing the second window to remain stationary and above the target window when the target window is active or in focus. Some embodiments are further directed to modifying target content in the target window in response to the activation of the second content (e.g., sorting target content based on activation of a sorting control within the second window, modifying number values in the target window based on number values of the second content, etc.).

### BACKGROUND

Embodiments of the inventive subject matter generally relate to the field of windowing, and, more particularly, to content and window overlaying.

Content display areas within windows are often restricted by space limitations and functionality of a window. For example, sometimes a user may wish to compare first content in one area of a window to second content in another area of the window. For instance, sometimes portion of content that may be used for comparison or reference, such as a table header, is fixed in one location of the window, such as at a top of the webpage or other document, while a remainder of the content, such as the table columns, are below the table header. A portion of the remainder of the content, however, may be outside of a current view of the window and a user may have to scroll to read the unseen remainder of the content. However, because of the space limitations of the window, when the user scrolls to see the remainder of the content (e.g., to view table cells that are out of the initial view of the window), the header scrolls out of view. Further, even if a user attempts to open two instances of the same content within two windows, the user is limited to viewing the separate content within the confines of the separate windows, which hide each other when stacked, have bulky borders and structures that interfere with content comparison, etc.

### SUMMARY

Some embodiments of the inventive subject matter are directed to selecting an area of a first window, which contains first content, in response to user input, generating a second window that contains second content that is substantially similar to a portion of the first content contained within the area of the first window, and superimposing the second window over a target window. The target window can be the first window or a third window. Some embodiments are further directed to affixing the second window to remain stationary and above the target window when the target window is active or in focus. Some embodiments are further directed to modifying target content in the target window in response to the activation of the second content (e.g., sorting target content based on activation of a sorting control within the second window, modifying number values in the target window based on number values of the second content, etc.).

### BRIEF DESCRIPTION OF THE DRAWINGS

The present embodiments may be better understood, and numerous objects, features, and advantages made apparent to those skilled in the art by referencing the accompanying drawings.

FIGS. 1A-1C are example conceptual diagrams of overlaying and affixing content according to some embodiments.

FIG. 2 is a flowchart depicting example operations for overlaying and affixing content according to some embodiments.

FIGS. 3-6 are example conceptual diagrams of overlaying, affixing, and modifying content for comparison and reference according to some embodiments.

FIG. 7 is a flowchart depicting example operations for merging overlaid content.

FIG. 8 depicts an example computer system.

### DESCRIPTION OF EMBODIMENT(S)

The description that follows includes example systems, methods, techniques, instruction sequences, and computer program products that embody techniques of the present inventive subject matter. However, it is understood that the described embodiments may be practiced without these specific details. For instance, although examples refer to windows, other instances may include layers within a window, presentations layers between displays, some combinations therefore, etc. In other instances, well-known instruction instances, protocols, structures, and techniques have not been shown in detail in order not to obfuscate the description.

To date, comparison and referencing of content across window areas and across different windows has been limited to current windows space limitations and functionality.

Embodiments of the inventive subject matter propose operations that select a portion of first content from an area of a first window, and generate a presentation layer, such as the second window or a layer on which to present content. The operations can further present second content in the presentation layer. The second content substantially represents (e.g., is a reproduction of, is another instance of, etc.) the portion of the first content that was in the first window. The operations can further overlay the presentation layer onto a target window. In some instances, the first window may be referred to as a “source” window and the first content of that window may be referred to as “source” content. In some embodiments, the target window is the source window, and the operations overlay the presentation layer at a location associated with the area from which the portion of the source content was selected. In other embodiments, the operations can overlay the presentation layer above a third window that is separate from the source window.

Further, in some embodiments, the operations can affix a layering order for the presentation layer above a layering order for the target window so that the second content of the presentation layer is viewable above the target window, even while user input is focused on the target window. The operations can also modify the target window and its content, based on user input within the presentation layer after the overlay (e.g., modify a sorting order of a column of data in the target window by selecting a control in the presentation layer). In some embodiments, the operations can adjust appearance of the presentation layer, the second content, the target window, and/or the target content in response to the overlaying operations and/or in response to user input, such as to reformat characteristics (e.g., shape, dimensions, text type, text location, content structure, etc.), modify transparencies, create offsets, etc. In some embodiments, the operations can merge the cloned content with the target content (e.g., combine columns of data, add together values, average values, perform calculations on data according to user-defined functions, etc.).

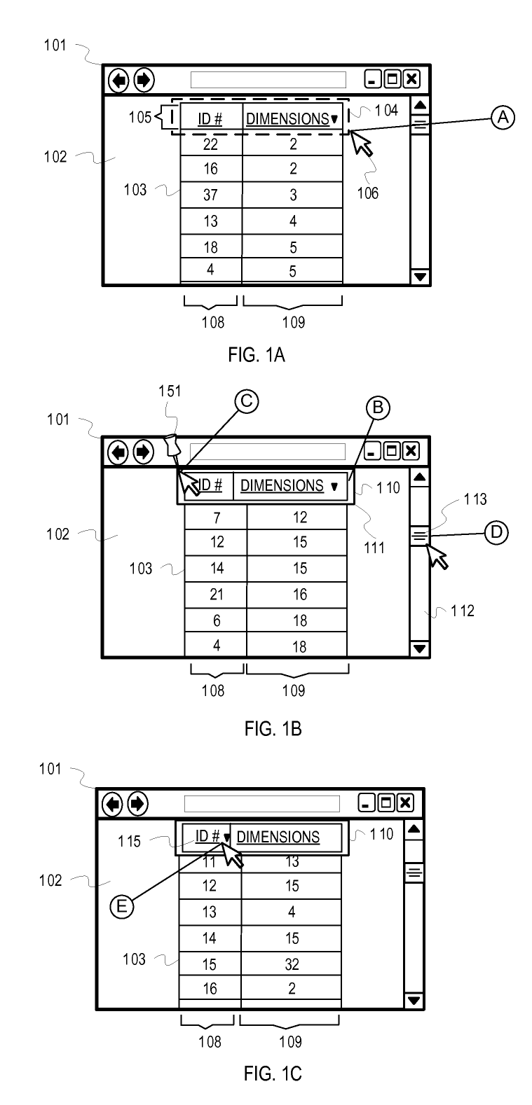

FIGS. 1A-1C are example conceptual diagrams of overlaying and affixing content according to some embodiments. In FIG. 1A, a computer presents a window 101. The window 101 present content 102, which includes a table 103. At stage “A,” an overlay controller, configured for embodiments of the inventive subject matter, detects first user input that selects an area 104 of the content 102, such as a header 105 of the table 103. The overlay controller detects the user input via a user input device, such as via a mouse that controls a mouse pointer 106. The table 103 includes two columns, a first column 108 and a second column 109. The first column 108 specifies an identification number for a group of items. The second column 109 specifies dimensions of the items that correspond to the identification numbers. The data in the table 103 is sorted initially according to values of the second column 109 (e.g., the table data is sorted in ascending order according to the dimensions of the item).

At stage “B,” as illustrated in FIG. 1B, the overlay controller generates a presentation layer 110 and overlays the presentation layer 110 over the window 101, such as in response to the first user input or additional user input. The presentation layer 110 includes a representation of the header 105. For instance, the representation is a clone of the portion of the content 102 selected within the area 104 specified in FIG. 1A, and only displays the portion of the content 102 that was in the area 104. Specifically, the presentation layer 110 can be a second window that loads the entire content 102 into the second window, and only shows the portion of the content 102 that was contained within the area 104 while hiding the remainder of the content 102 that was not in the area 104. The presentation layer 110, however, may have a minimal visible structure, such as only a thin border 111, so as not to significantly obscure content beneath it.

At stage “C,” the overlay controller affixes the presentation layer above the content 102, such as in response to the first user input or additional user input. For example, the overlay controller can display a graphic 151 that indicates to a user that a mouse click will pin the presentation layer 110 in the location where it was overlaid. In other embodiments, however, the overlay controller can automatically pin the presentation layer 110 without requiring user input. The overlay controller can affix the presentation layer above the content 102 by setting a window order for the presentation layer 110 above a window order of the window 101. At stage “D,” the overlay generator detects a shift of focus to the window 101. For example, a user input, via the mouse pointer, clicks onto a scroll control 113 of a scroll bar 112 and moves a scroll control 113 downward, which causes the view of the content 102 to move upward (e.g., scrolls the data in the first column 108 and the second column 109 upward in unison). However, even though the additional user input selects the first window 101 (e.g., selects a feature of the first window such as the scroll control 113) and performs a scroll function, which causes the values in the table 103 to move, the overlay controller maintains a window order of the presentation layer 110 above that of the window 101. Thus, the presentation layer 110 remains visible. Further, the overlay controller maintains a position for the presentation layer 110 fixed in relation to the window 101. Thus, when the additional user input, at stage “D” scrolls the content 102, the content in the presentation layer 110 remains stationary, and can be used to compare the content in the presentation layer 110 as a reference against the content 102 in the window 101.

At stage “E,” as illustrated in FIG. 1C, the overlay controller detects additional user input within the presentation layer 110 that causes a response to the content 102. For example, as described previously, the data in the table 103 was sorted in ascending order according to the values of the second column 109. At stage “E,” the overlay controller detects additional user input that activates a sorting control 115 associated with the first column 108, and in response, the overlay controller resorts the data in the table 103 according to the values in first column 108.

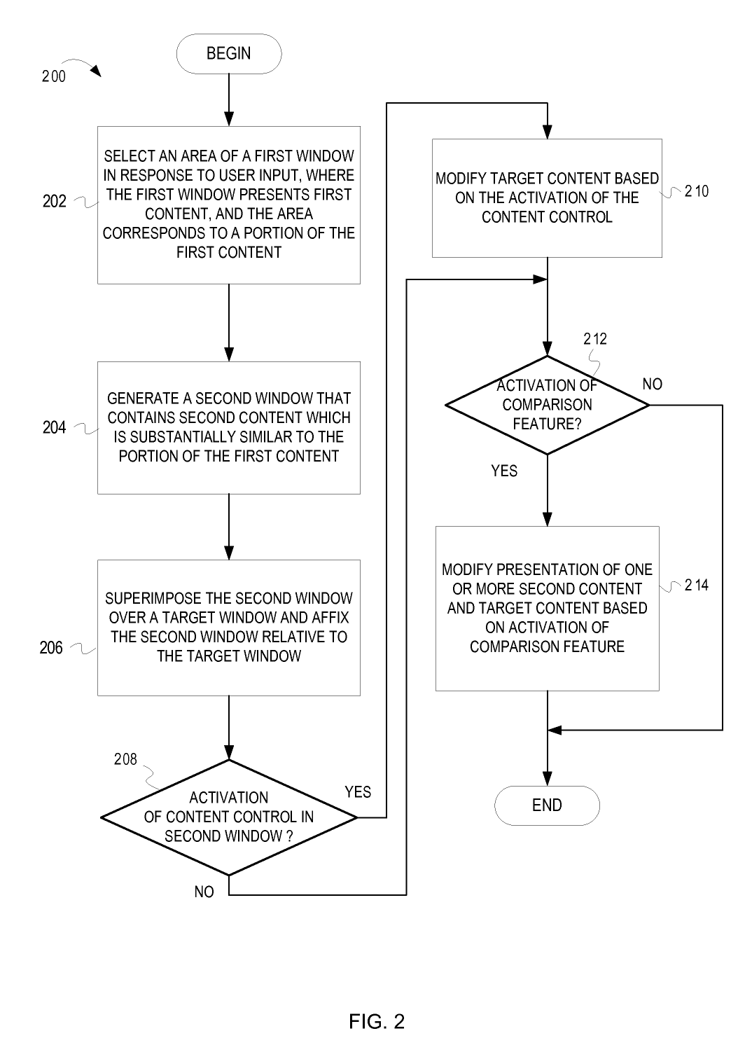

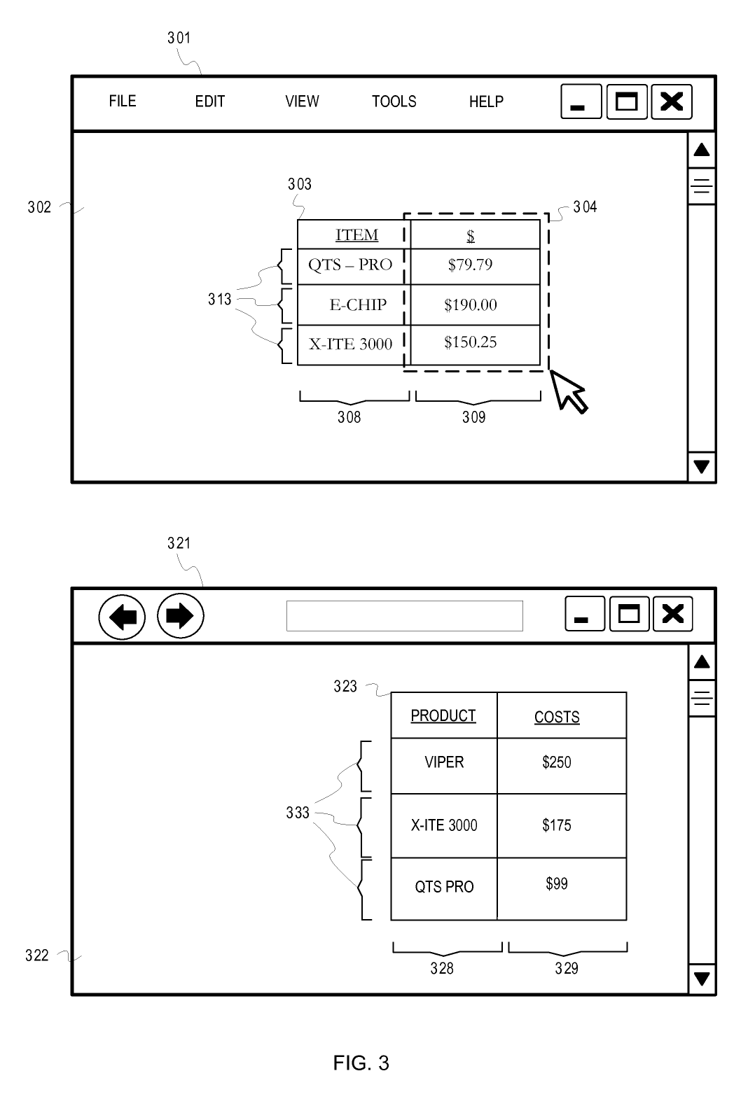

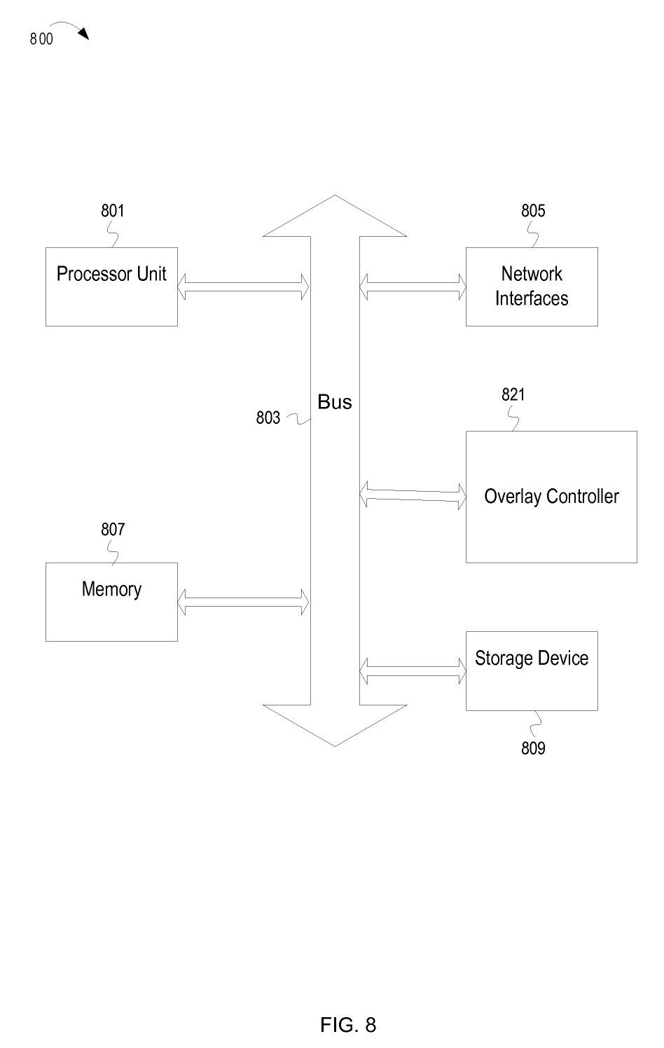

FIG. 2 is a flowchart depicting example operations for overlaying and affixing content according to some embodiments. For example purposes, operations associated with the blocks in FIG. 2 will be described as being performed by a content-overlay system (“system”), which may, for example, include any or all of the elements described in FIG. 1 and/or FIG. 8, such as an overlay controller. FIG. 2 illustrates a flow 200 that the system can perform. FIGS. 3-6 are example conceptual diagrams of overlaying, affixing, and modifying content for comparison and reference according to some embodiments. The description of FIG. 2 will refer to FIGS. 3-6, and also occasionally back to FIG. 1.

Referring to FIG. 2, the system selects an area of a first window in response to user input, where the first window presents first content, and the area corresponds to a portion of the first content (202). For example, the system selects an area of the first window in response to user input as similarly described above in FIG. 1. In some embodiments, the system detects user input that specifies a boundary that bounds, or surrounds, the area of the first window. The portion of the content is contained within the boundary. The system can detect coordinates associated with the boundary and store the coordinates (e.g., in a file, in a buffer, etc.) for later access. In other embodiments, the system can select objects or sections of the first content that appears to be a unit of data. For example, the system can detect a user mouse click on an object such as a graphic, a border, a tab, a page, a cell in a column or row, etc., any of which objects may be associated with other portions of the content (e.g., clicking on one part of a graphic implies selection of the entire graphic without having to draw around the borders of the graphic, clicking on a cell in a column header implies selection of the entire column without having to draw around the borders of the entire column, etc.). When the system is uncertain about what area to automatically select, the system can prompt the user to clarify. For example, if a user clicks on a cell in a table header, the system can generate a prompt that specifies to select either the header or the column (e.g., present selectable graphics for the two options for a user to select). The system can further read settings that indicate specific keystroke combinations and/or mouse movements that, in connection with mouse clicks, specify certain selections actions (e.g., a click on a cell in combination with a press of the Ctrl+R keys and a sideways movement of the mouse will select a row).

Referring still to FIG. 2, the system generates a second window that contains second content which is substantially similar to the portion of the first content (204). The second window can be approximately equal in dimensions to the area that was previously selected. The system presents within the second window the second content, which is substantially similar to the portion of the first content. In some embodiments, the second content is a reproduction of the content that was bounded within the selection of the first area (e.g., a graphical snapshot, such as a screen capture of only the portion of the first content). In other embodiments, however, the system clones the first content within the second window to have all of the characteristics, metadata, functionality, etc. associated with the first content. For instance, the first window and the second window may be associated with the same application. The system, can thus instantiate the second window, via the application, and load the first content contained within the first window into the second window. The system further accesses the coordinates data associated with the selection of the area of the first window that was previously stored and uses the coordinates data to create the size of the second window. The system also uses the coordinates data to display within the second window only a representation of the portion of the first content that corresponded to the previous selection. For example, the system selects a second area of the second content (which is the cloned portion of the first content), which second area corresponds to the original coordinates of the area of the previous selection of the area of the first window, and narrows the view of the second window to only those coordinates. The system can then lock the view for the second window in place so that it continuously only displays only the representation of the portion of the first content.

Referring to FIG. 2, the system superimposes the second window over a target window and affixes the second window relative to the target window (206). The target window can be the first window. If the system superimposes the second window over the first window, the system can automatically superimpose the second window at a location that corresponds to the area that was selected. The system can use the coordinates that were previously stored when the portion of the content was selected from the area of the first window. In some embodiments, the system can use one of the coordinates, such as an upper right hand coordinate for the selected area, and superimpose the second window that is approximate in size to the first area with a second coordinate of the upper right hand corner coinciding exactly with the one coordinate for the upper right hand corner of the selected area. In other examples, however (as shown in FIGS. 3-6), the target window can be a third window that is different from the first (“source”) window. The first window may be associated with a first application and the third window may be associated with a second application. The first and second applications can be independent from each other (e.g., written in different programming languages, running using different processor threads, created by different software manufacturers, etc.). The second window can be an instance of either the first or second application. In embodiments where the target window is different from the first window (e.g., the target window is a third window), the system can detect a coordinate specified by player input and superimpose the second window using the coordinate specified by player input. For example, the system can detect a mouse click of where to position the second window onto the third window. The system can affix the second window to the target window at a location that corresponds to the area that was selected.

Further, as specified previously, the system affixes the second window relative to the target window. The target window has a first window order (when initially displayed via a display, the target window was assigned the first window order), such as indicated via a current state of a windows operating system that controls ordering for the target window and the second window. The system can assign a second window order to the second window so that the second window order exceeds the first window order, causing the second window to appear above the first window when viewed via a display. The system holds, or fixes, the second window order above that of the first window order (e.g., for a duration of an existence of the target window). The system can affix the second window order to remain above the first window order even when the target window is selected and manipulated via user interaction. For example, the system can detect user input that focuses activity on of the target window, and the system can maintain the second window order above the first window order while the target window is active or focused (e.g., if a user clicks in the target widow, and keyboard/mouse input is activated for that target window, the second window stays in place as the top window). In some examples, the system detects user input within the target window that changes the position of content within the target window (“target content”). However, the system maintains the appearance of the second content steady despite the user input within the target content (e.g., if a user scrolls the content in the first window up and down or left and right, the second window does not scroll). The system can also detect user input to the second window and cause the second window to move to a different location in response to the user input. In other examples, however, the system can cause the second window to respond automatically to user input via the target window. For example, the system can detect user input via the target window such as a minimization feature, a maximization feature, a close feature, etc., which can automatically minimize, maximize, or close of the second window.

Referring to FIG. 2, the system detects whether a content control is activated in the second content (208). If a content control is activated in the second content, the system modifies the target content based on the activation of the content control (210). For example, as similarly described in FIG. 1, the system can detect when user input activates a link, a feature, etc. within the second window (e.g., selection of the sorting control 115), which the system then uses to cause a reaction to the target content within the target window. Other examples of content controls may include controls used to open or close content, change content formats, modify content values, add content, etc. As previously described, the target window can be the first window and the second window can be a separate instantiation of the same application that controls functionality of the first window and the second window. When a content control, such as the sorting control 115, is activated via the second window, then both the second window and the first window can respond concurrently and equivalently to the activation of the content control using common code (e.g., functions, subroutines, etc.), for the same application that controls functionality of the first window and the second window. The concurrent response would not be seen in the second window because the representation of the first content in the second window would be hidden except for the portion represented in the second window. However the concurrent response would be seen in the first window because the first content is viewable in the first window. In other examples, where the target window is a third window controlled by a second application separate from the first application for first window, and if the second window is an instance of the first application, the system can transfer commands between the first application and the second application to cause the content in the third window to respond to the activation of the content control within the second window. In other examples, however, the system can instantiate the second window via the second application and convert the second content to formats, functionality, etc. used by the second application.

Referring to FIG. 2, the system detects whether a comparison feature is activated (212). If a comparison feature is activated, the system modifies presentation of second content and/or target content based on activation of the comparison feature (214). Comparison features are features that modify the appearance of either the second content or the target content to ensure that the second content and the first content are easily comparable. Comparison features can be activated via direct user input or automatically. One example of comparison features includes modifying the content in one window based on characteristics or format of content in another window, such as formatting the second content to a format of the target content. For instance, if the second window is a column of data from the first window, and the first content was a first column structure type (e.g., the column of data in the first window possesses a table structure native to a word processing application) the system can convert the first column structure type to a second column structure type compatible with the target window (e.g., converts the word processing table structure to a hypertext markup language (HTML) table structure). The system can further modify other formatting, such as font type or size, colors, cell dimensions, numbering types, sorting, etc. The system, for instance, can modify the size and alignment of data columns in the second window so that when overlaid onto the target window, the cells in the second window line up to cells in the target window and can be visually comparable. Other examples of comparison features can include features that modify a transparency or offset of elements the second window or second content. For example, the system can cause borders, controls (e.g., for minimization, maximization, closing, moving, pinning, etc.), handles, structures, and other elements of the second window to become non-visible or less visible (e.g., increase a degree of transparency) so that the second window appears to be, primarily or exclusively, the second content floating above the target content or appearing to blend substantially into the target content without significant obstruction to the target content. In some instances, when the system detects user input to the second window (e.g., when a user clicks on the second window or when a mouse pointer hovers over the second window) the system can cause the non-visible, or less visible, elements of the second window to become more visible again (e.g., decrease the degree of transparency). In some embodiments, modifying transparency can include modifying transparency of a background of the second window, so that certain elements of the second content appear to float above the target window, such as causing a document background of the second content in the second window to become transparent, causing text from the second content to appear to float above the target window. In another example, the system can modify offset values of the second content, such as modifying a degree to which content in the second window moves to a position in the second window that provides for a visible comparison with the target content. For example, if the second content was a column of a table, with first values centered within the cells of the table, and it were to be overlaid onto another column of a table of the target content that also had second values centered within the cells, then a direct overlay would cause the first values to lay directly on top of the second values. The first and second values would be overlapped (i.e., reside in approximately the same space), and would be hard to visually distinguish from each other. The offset, however, could cause the first values, for instance, to move to a right hand side of the cells. In other example, the system can also cause the second values in the target window to offset as well, if necessary, such as to a left hand side of the cells.

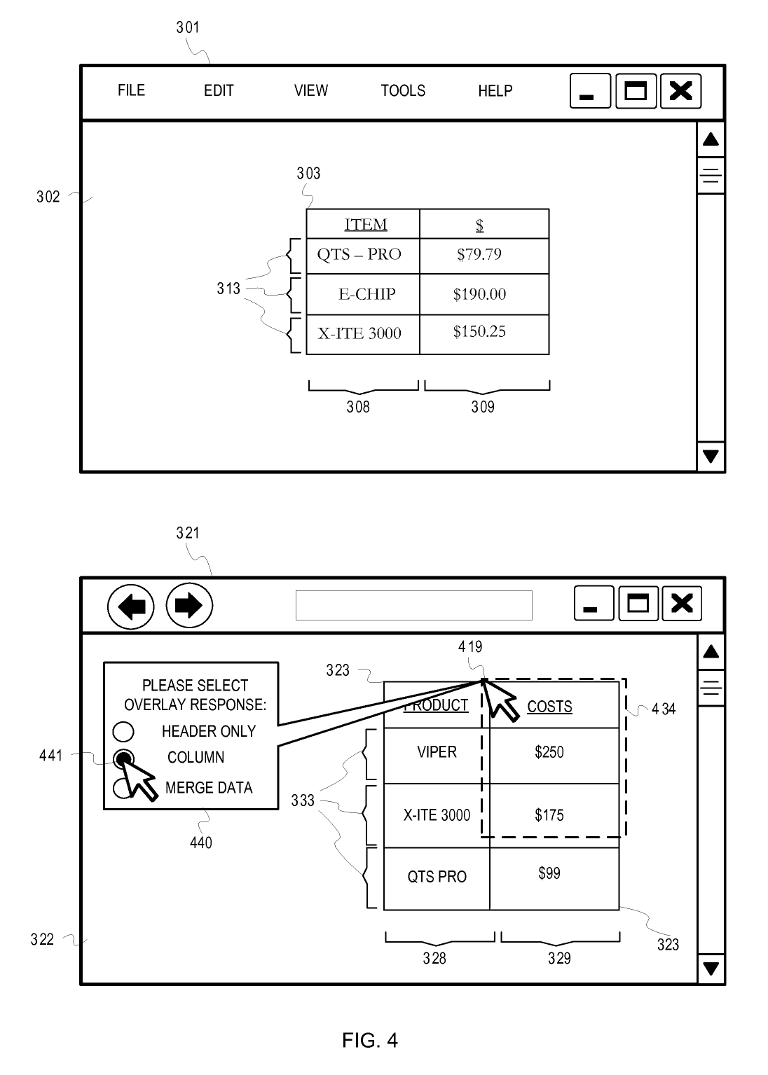

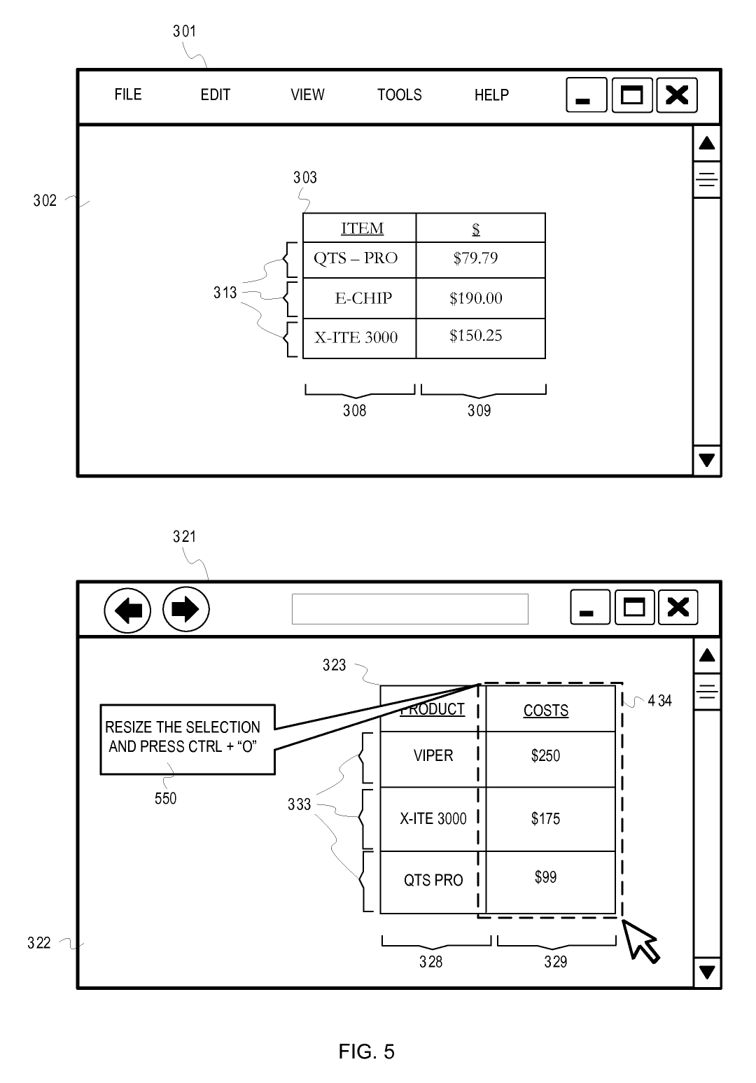

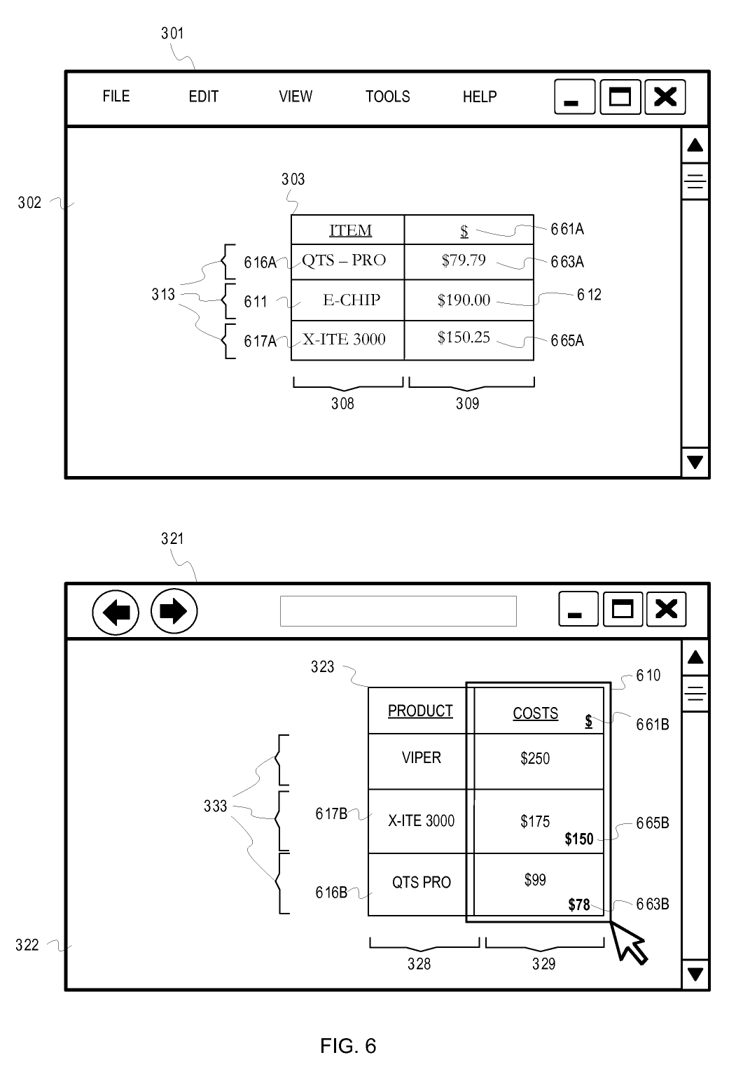

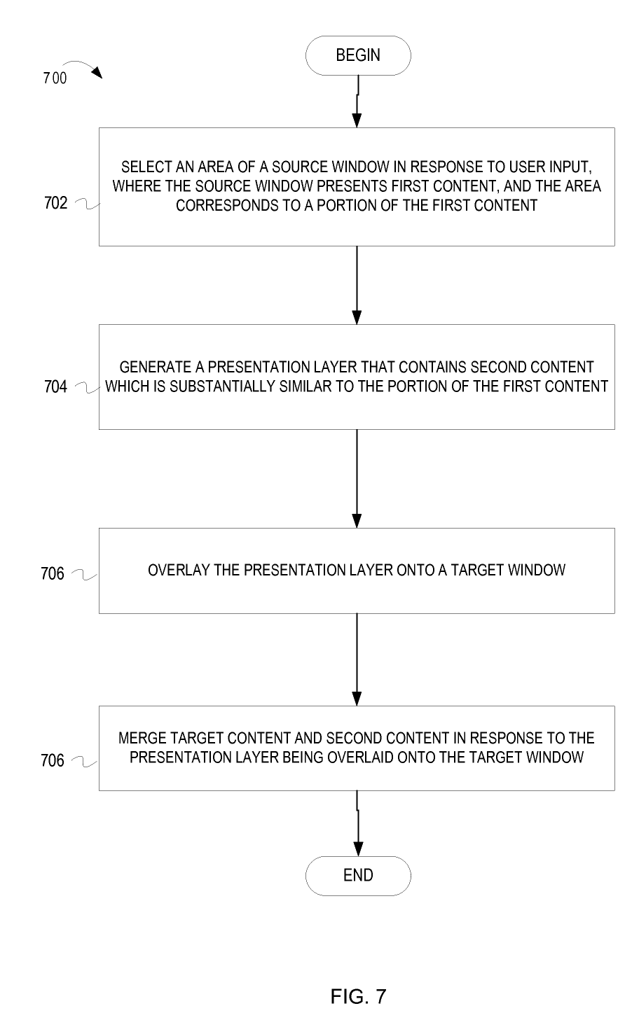

FIGS. 3-6 provide examples of modifying the second content for comparison. For example, in FIG. 3, a window 301 is associated with a first application type (e.g., a word processing application) and a window 321 is associated with a second application type (e.g., a browser application). The window 301 presents first content 302, such as a table 303 with a first column 308 and a second column 309 and multiple rows 313. The table 303 includes cells with certain values. For example, the first column 308 specifies values that describe a specific product. The second column 309 specifies values that describe a price or cost for the corresponding product. Each of the rows 313 has certain dimensions (e.g., each of the rows 313 are one-half inch in height). The table 323 has a third column 328 and a fourth column 329, as well as rows 333 that have different dimensions of the rows 313 (e.g., each of the rows 333 are one inch in height). The system detects that a user selects an area 304 of the table, such by highlighting the second column 309 with a mouse pointer combined with a first key stroke combination (e.g., Ctrl+R). In FIG. 4, the system detects user input within the window 321 at point 419, such as via a click of the mouse when the mouse pointer is at point 419 combined with a second key stroke combination (e.g., Ctrl+P). A resizable box 434 appears, which represents, when originally generated, a size of the area 304 made in FIG. 3. Still referring to FIG. 4, the system also presents a message 440 that requests user input regarding a type of overlay feature to implement, such as to overlay only a header or an entire column, or to perform a merge of data (e.g., see FIG. 7 below for further description of data merging according to some embodiments). The system detects a selection of option 441, to overlay a representation of the second column 309. Referring to FIG. 5, the system detects a resizing of the box 434 to indicate a desired size over which the representation of the second column 309 will be positioned. The system can further present an additional message 550 instructing to enter another key stroke combination (e.g., Ctrl+O). In FIG. 6, the system generates a window 610 and superimposes the window 610 over the table 323. The second column 309, from table 303, has values 661A, 663A, and 665A, which are positioned in the table 303 according to the one-half inch in height. After the window 610 is superimposed over the table 323 in the window 321, the system positions data values 661B, 663B, and 665B (which correspond to data values 661A, 663A, and 665A) over the fourth column 329 according to the one-inch height spacing of the rows 333. The system, therefore, detected the height of the rows 333 and adjusted the positioning of the values 661B, 663B, and 665B accordingly. Further, the font for the values 661A, 663A, and 665A are of one font type. The system, however, detects that the font associated with the table 323 is a second font type, and, therefore, automatically formats the values 661B, 663B and 665B to be of the second font type. The system also modified a number format for values 663B and 665B to have no decimal point values, and also rounded the values up to the nearest dollar value to match a number format of the table 323. The system can also, in some embodiments, convert the content within the window 610 from a table structure for the first table 303 (e.g., from a word processing table format) to a table structure for the second table 323 (e.g., to an HTML table format) and offset the values 661B, 663B, and 665B to appear to be in the lower right hand corners of the fourth column 329. The system can also make a background for the window 610 to appear transparent so that the fourth column 429 is viewable through the window 610.

In some embodiments, the system can evaluate selected content against other content values and modify the superimposed second content accordingly. For example, in FIG. 6, the system detects that some of the values from the second column 309 were irrelevant to the values in the fourth column 329 based on data elsewhere in the table 303 the table 323. For example, values 663A and 665A are associated with product values 616A and 617A. When the window 610 is overlaid, the system can detect that the table 323 includes values 616B and 617B that are substantially equivalent to the values 616A and 617A. As a result, upon the overlay of the second table 610, the system overlays the values 663B and 665B for the corresponding rows associated with values 616B and 617B. The system determines that a value 611 for one of the products (i.e., the “E-Chip” product) in table 303 is not found in the table 323. As a result, the system disregards the dollar value 612 associated with the value 611 and does not overlay that dollar value 612 over the table 323.

FIG. 7 is a flowchart depicting example operations for merging overlaid content. For example purposes, operations associated with the blocks in FIG. 7 will be described as being performed by a content-overlay system (“system”), which may, for example, include any or all of the elements described in FIG. 1, FIG. 2, FIGS. 3-6, and/or FIG. 8, such as an overlay controller. FIG. 7 illustrates a flow 700 that the system can perform.

Referring to FIG. 7, the system selects an area of a source window in response to user input, where the source window presents first content, and the area corresponds to a portion of the first content (702). The system generates a second window that contains second content which is substantially similar to the portion of the first content (704). Further, the system overlays the second window onto a target window (706). Examples of selecting an area, generating a second window, and superimposing the second window were described previously.

Referring to FIG. 7, the system further merges target content and second content in response to the second window being overlaid onto the target window (708). For example, when the second window is overlaid, the system can merge or combine content values from the second content with values in the target content. The overlaying can trigger content combination or merging. The system automatically and dynamically modifies content values in the target window based on the values included in the second window. For example, the system performs specific functions, operations, etc. that use both the values in the second content and the values in the target content to generate new values. The functions, for instance, can add the values, multiply the values, average the values, or perform other computational operations.

In some embodiments, during a merge process, or in other examples, the system can restrict, or protect, content in the target window being modified based on user preference or indication prior to being overlaid. For example, the system can detect user input, prior to an overlay operation, which user input specifies that a column header from a table on the target window should not change even if overlaid by a column header in the second window. Thus, when the second window overlaid, even if the overlaid column header has a different header name, the user preference is honored, and the header name for the target window is used instead, changing the specific column header in the second window to be that of the specific column header from the target window. Others of the column headers from the target window that were not specified as being protected, however, could be overwritten or overlaid based on the column header names from the second window. The system can also protect specific columns, specific rows, specific cells, specific portions of objects, specific graphics, specific text, specific numerical values, etc.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 8 depicts an example computer system 800. The computer system 800 includes a processor unit 801 (possibly including multiple processors, multiple cores, multiple nodes, and/or implementing multi-threading, etc.). The computer system 800 includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media or computer readable storage media. The computer system 800 also includes a bus 803 (e.g., PCI bus, ISA, PCI-Express bus, HyperTransport® bus, InfiniBand® bus, NuBus bus, etc.), a network interface 805 (e.g., an ATM interface, an Ethernet interface, a Frame Relay interface, SONET interface, wireless interface, etc.), and a storage device(s) 809 (e.g., optical storage, magnetic storage, etc.). The computer system 800 also includes an overlay controller 821. The overlay controller 821 can control selecting, generating, overlaying, and modifying content for comparison, reference, etc. according to embodiments of the inventive subject matter. Any one of these functionalities may be partially (or entirely) implemented in hardware and/or on the processing unit 801. For example, the functionality may be implemented with an application specific integrated circuit, in logic implemented in the processing unit 801, in a co-processor on a peripheral device or card, etc. Further, realizations may include fewer or additional components not illustrated in FIG. 8 (e.g., video cards, audio cards, additional network interfaces, peripheral devices, etc.). The processor unit 801, the storage device(s) 809, and the network interface 805 are coupled to the bus 803. Although illustrated as being coupled to the bus 803, the memory 807 may be coupled to the processor unit 801.

While the embodiments are described with reference to various implementations and exploitations, it will be understood that these embodiments are illustrative and that the scope of the inventive subject matter is not limited to them. In general, techniques for overlay, modifying, and otherwise integrating content as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer-implemented method comprising:
selecting an area of a first window in response to first user input, wherein the first window presents first content, and wherein the area corresponds to a portion of the first content;
generating a second window that is approximately equal in dimensions to the area;
presenting, within the second window, second content substantially similar to the portion of the first content;
superimposing the second window over the first window; and
affixing the second window above the first window, wherein the affixing causes the second window to remain above the first window when the first window receives second user input.

2. The computer-implemented method of claim 1, wherein the affixing the second window above the first window further comprises:
affixing the second window to remain stationary when the first content in the first window moves in response to the second user input.

3. The computer-implemented method of claim 1 further comprising:
detecting activation of the second content in the second window; and
modifying presentation of the first content in the first window in response to the activation of the second content.

4. The computer-implemented method of claim 1 further comprising:
during generation of the second window, generating a clone of a content control that is in the portion of the first content, wherein the content control is configured to modify presentation of an additional portion of the first content in the first window;
presenting the clone of the content control in the second window,
detecting activation of the clone of the content control within the second window via a third user input; and
modifying presentation of the additional portion of the first content in response to the activation of the clone of the content control.

5. The computer-implemented method of claim 1 further comprising:
removing visibility of one or more elements of the second window, wherein said removing visibility of the one or more elements of the second window causes the second content to appear to blend into a view of the first content.

6. The computer-implemented method of claim 1, wherein said superimposing the second content over the first window comprises automatically superimposing the second window at a location that corresponds to the selection of the area in response to the generating the second window.

7. The computer-implemented method of claim 1, wherein said presenting, within the second window, second content substantially similar to the portion of the first content comprises:
instantiating the second window via an application that controls presentation of the first content;
generating a clone of the first content within the second window; and
hiding the clone of the first content within the second window except for a portion of the clone of the first content associated with a location of the area selected via the first window.

8. A computer program product for content modification via overlay, the computer program product comprising:
a computer readable storage medium having computer readable program code embodied therewith, the computer readable program code comprising:
computer readable program code configured to,
select an area of a first window in response to user input, wherein the first window presents first content, and wherein the area corresponds to a portion of the first content,
generate a second window,
present, within the second window, second content substantially similar to the portion of the first content,
overlay the second window over a third window, and
modify third content within the third window in response to an overlay of the second content over the third window.

9. The computer program product of claim 8, wherein the first window is associated with a first application and the third window is associated with a second application independent from the first application.

10. The computer program product of claim 8, said computer readable program code being configured to modify the third content being configured to,
modify a first format of the second content to match a second format of the third content.

11. The computer program product of claim 8, said computer readable program code being configured to modify the third content being configured to one or more of modify an offset of a location of a first value contained within the second content in relation to a second value contained within the third content, modify a textual characteristic of a first value contained within the second in relation to a second value contained within the third content, and modify a first table structure of a first table element contained within the second content to a second table structure of a second table element in the third content.

12. The computer program product of claim 8, said computer readable program code being configured to modify the third content being configured to,
merge a first value contained within the second content with a second value contained within the third content.

13. The computer program product of claim 8, said computer readable program code being further configured to,
affix the second window above the third window, wherein the affixing causes the second window to remain above the third window when the third window receives an additional user input.

14. The computer program product of claim 8, said computer readable program code being further configured to,
evaluate first values in the first content against second values in the third content, and
exclude an overlay of a portion of the second content in response to evaluation of the first values of the first content against the second values in the third content.

15. The computer program product of claim 8, said computer readable program code being further configured to,
detect a selection of a portion of the third content prior to overlay of the second content, and
protect the portion of the third content from being modified during the overlay of the second content.

16. An apparatus comprising:
a processing unit; and
an overlay controller operable to, via the processing unit,
select an area of a first window in response to first user input, wherein the first window presents first content, and wherein the area corresponds to a portion of the first content,
generate a second window,
present, within the second window, second content substantially similar to the portion of the first content,
superimpose the second window over the first window, and
affix the second window above the first window to cause the second window to remain stationary and above the first window when the first window receives second user input.

17. The apparatus of claim 16, said overlay controller being further operable to,
instantiate the second window via an application that controls presentation of the first content;
generate a clone of the first content within the second window; and
hide the clone of the first content within the second window except for a portion of the clone of the first content associated with a location of the area selected via the first window.

18. The apparatus of claim 16, said overlay controller being further operable to,
modify a first format of the second content to match a second format of the first content.

19. The apparatus of claim 16, said overlay controller being further operable to,
calculate a first value contained within the second content with a second value contained within the first content.

20. The apparatus of claim 16, said overlay controller being further operable to,
detect an activation of a content control within the second content in the second window, and
modify presentation of the first content in the first window in response to the activation of the content control.
